(19) United States
(12) Patent Application Publication
(10) Pub. No.: US 2025/0289310 A1
(43) Pub. Date: Sep. 18, 2025

(54) DISPLAY DEVICE AND METHOD OF CONTROLLING DISPLAY DEVICE

(71) Applicant: HONDA MOTOR CO., LTD., Tokyo (JP)

(72) Inventor: Takashi Noguchi, Tokyo (JP)

(21) Appl. No.: 19/015,203

(22) Filed: Jan. 9, 2025

(30) Foreign Application Priority Data
Mar. 12, 2024 (JP) 2024-038361

(51) Int. Cl. B60K 35/81; B60K 35/22

(52) U.S. Cl. CPC B60K 35/81; B60K 35/22; B60K 2360/1868

(57) ABSTRACT

A display device mounted on a vehicle, including: a display unit, wherein the vehicle has a driver's seat for a driver who drives the vehicle to sit and an occupant seat for a passenger of the vehicle to sit, the driver's seat and the occupant seat being arranged side by side, and the display unit is provided extending from the driver's seat to the occupant seat; an operation unit that receives an operation onto an operation area provided on the display unit; a display control unit that causes content to appear on a display area of the display unit; and a control unit that adjusts at least one of the operation area and the display area on the display unit depending on a driving state of the vehicle and a use state of a steering operation unit of the vehicle.

### INCORPORATION BY REFERENCE

The present application claims priority under 35 U.S.C. § 119 to Japanese Patent Application No. 2024-038361 filed on Mar. 12, 2024. The content of the application is incorporated herein by reference in its entirety.

### BACKGROUND OF THE INVENTION

### Field of the Invention

The present invention relates to a display device and a method of controlling a display device.

### Description of the Related Art

In recent years, research and development on improving operability has been conducted in order to ensure that more people have access to affordable, reliable, sustainable and advanced energy. For example, Japanese Patent Laid-Open No. 2021-154770 discloses a technique in which an in-vehicle device restricts a display of information on the display unit and an operation input to an operation unit depending on a driving state of the vehicle.

The shapes and sizes of display devices and operation units provided in vehicles are diversifying. For this reason, a technique is desired that enables appropriate display and operation to be executed in response to the state of the vehicle and achieves improved operability.

The present application aims to improve operability of a display device provided in a vehicle in order to solve the above problems. Furthermore, the present application will ultimately improve traffic safety even further to contribute to development of sustainable transportation systems.

### SUMMARY OF THE INVENTION

An aspect of the present disclosure is a display device mounted on a vehicle, including: a display unit, wherein the vehicle has a driver's seat for a driver who drives the vehicle to sit and an occupant seat for a passenger of the vehicle to sit, the driver's seat and the occupant seat being arranged side by side, and the display unit is provided extending from the driver's seat to the occupant seat; an operation unit that receives an operation onto an operation area provided on the display unit; a display control unit that causes content to appear on a display area of the display unit; and a control unit that adjusts at least one of the operation area and the display area on the display unit depending on a driving state of the vehicle and a use state of a steering operation unit of the vehicle.

According to an aspect of the present disclosure, the display area and the operation area of the display unit can be appropriately arranged that extend from the driver's seat to the occupant seat of the vehicle, thereby improving operability.

### BRIEF DESCRIPTION OF THE DRAWINGS

FIG. 1 is a diagram showing a configuration of a vehicle equipped with a display device;

FIG. 2 is a perspective view of main parts showing a configuration example of a passenger compartment of the vehicle;

FIG. 3 is a perspective view of the main parts showing a configuration example of the passenger compartment of the vehicle;

FIG. 4 is a diagram showing a setting example of a display area and an operation area;

FIG. 5 is a flowchart showing an actuation example of the display device;

FIG. 6 is a flowchart showing an actuation example of the display device;

FIG. 7 is a flowchart showing an actuation example of the display device; and

FIG. 8 is a flowchart showing an actuation example of the display device.

### DETAILED DESCRIPTION OF THE INVENTION

Hereinafter, an embodiment of the present invention will be described with reference to the drawings.

### 1. Configuration of the Display Device and Vehicle

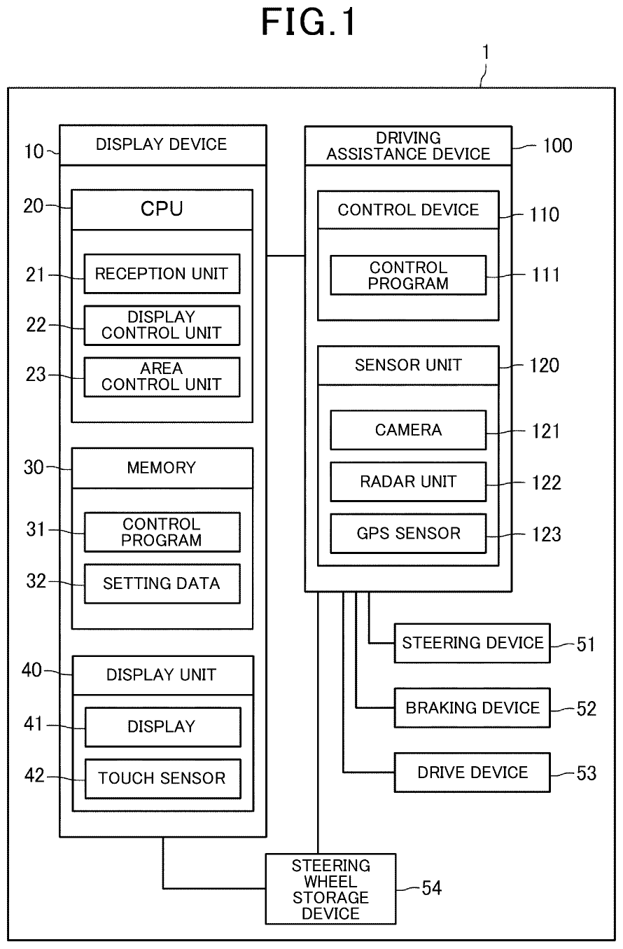

FIG. 1 is a diagram showing a configuration of a vehicle 1 equipped with a display device 10.

The display device 10 is a device having a display unit 40 that displays characters and images, and is mounted on the vehicle 1. The vehicle 1 is a vehicle in which a person can gets, and may be either a four-wheeled vehicle or another vehicle, such as a large vehicle, a commercial vehicle, or a work vehicle. The occupants of the vehicle 1 are referred to as occupants below. One of the occupants is the driver who drives the vehicle 1. The vehicle 1 is a vehicle on which an occupant other than the driver can ride, that is, a passenger.

A driving assistance device 100 is connected to the display device 10.

The driving assistance device 100 is a device that executes autonomous driving of the vehicle 1, and performs so-called automatic driving. The driving assistance device 100 includes a control device 110 and a sensor unit 120. The driving assistance device 100 is connected to a steering device 51, a braking device 52, and a drive device 53 of the vehicle 1. The steering device 51 includes a steering mechanism that steers the vehicle 1. The braking device 52 is a brake device of the vehicle 1. The drive device 53 includes a motor or an engine that is the drive source of the vehicle 1, and includes a throttle device or a fuel injection device that controls the actuation of the drive source. The drive device 53 may include a speed change mechanism that changes the output of the drive source. The steering device 51, the braking device 52, and the drive device 53 include actuators and motors as drive sources for actuating the above devices when the driver does not operate them.

The control device 110 is a computer that includes: a processor composed of a CPU (Central Processing Unit), an MPU (Micro Processing Unit), or other integrated circuits; and a memory that stores programs and data. The control device 110 executes a control program 111 to perform control related to driving of the vehicle 1.

The sensor unit 120 includes sensors with which the control device 110 controls driving. For example, the sensor unit 120 includes a camera 121, a radar unit 122, and a GPS (Global Positioning System) sensor 123. The camera 121 is a digital camera that captures images of the outside of the vehicle 1. The radar unit 122 detects objects located outside the vehicle 1. The GPS sensor 123 identifies the position of the vehicle 1 by receiving GPS signals with an antenna (not shown). The sensor unit 120 may be provided with sensors not shown in FIG. 1, and may include, for example, a LiDAR (Light Detection And Ranging) unit. The sensor unit 120 may also include various sensors such as a vehicle speed sensor provided on the vehicle 1.

The control device 110 executes the control program 111 to perform autonomous driving of the vehicle 1. For example, the control device 110 acquires detection data indicating detection values of the sensor unit 120. The control device 110 actuates the steering device 51, the braking device 52, and the drive device 53 based on the detection data of the sensor unit 120.

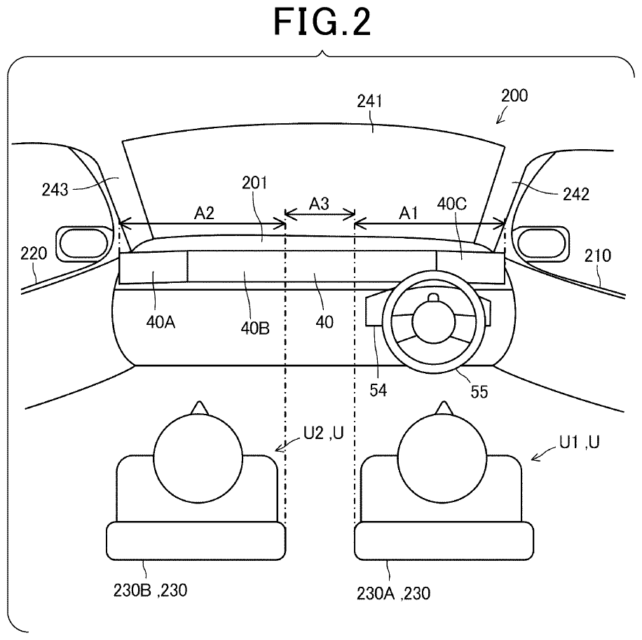

The vehicle 1 includes a steering wheel 55 (FIG. 2) that actuates the steering device 51, a brake pedal that actuates the braking device 52, and an accelerator pedal that actuates the drive device 53, which are not shown. These function as operation units for the driver to drive the vehicle 1. The driver can drive and operate the vehicle 1 by operating the steering wheel 55, the brake pedal, and the accelerator pedal. In other words, the vehicle 1 is a vehicle that can be switched between manual driving, in which the vehicle travels according to the driving operation by the driver, and automatic driving, in which the vehicle travels under the control of the driving assistance device 100 without the driver performing driving operation. Whether the vehicle 1 is being driven automatically or manually is referred to as the driving state of the vehicle 1 below. The steering wheel 55 corresponds to an example of a steering operation unit.

The display device 10 includes a display unit 40. The display unit 40 is installed in the passenger compartment of the vehicle 1 and includes a display 41 and a touch sensor 42. The display 41 is composed of a display panel such as a liquid crystal display panel or an organic EL (Electro Luminescence) panel, and displays characters and images. The touch sensor 42 is a sheet-like sensor stacked on the display surface of the display 41 and detects touch operations by the occupant. The touch sensor 42 is arranged to cover almost the entire area of the display surface of the display 41, and can detect touch operations in the entire area where the display 41 displays characters and images.

In the following description, the entire area on the display 41 where images and characters can be displayed is referred to as a displayable area, and the entire area on the touch sensor 42 where operations can be detected is referred to as a detectable area. The displayable area is almost the entire display 41 excluding the outer frame, and the touch sensor 42 overlaps most of the displayable area.

The display device 10 includes a CPU (Central Processing Unit) 20 and a memory 30 (corresponding to a storage unit) that stores programs and data to be executed by the CPU 20. The memory 30 is a non-volatile storage device composed of a magnetic storage medium or a semiconductor storage element. The memory 30 stores, for example, a control program 31 and setting data 32.

The CPU 20 reads and executes the control program 31 to function as a reception unit 21, a display control unit 22, and an area control unit 23. The reception unit 21 detects operations on the touch sensor 42 and accepts input based on the detected operations. The display control unit 22 causes content to appear on the display 41. Here, the content includes characters and images displayed on the display 41, and has no limitation on what it is. For example, the content may be information about the actuation state of the vehicle 1, information about the operation of the vehicle 1, maps and guidance information related to the functions of the navigation device included in the vehicle 1, entertainment images from movies and television broadcasts, etc. The reception unit 21 corresponds to an example of an operation unit, and the area control unit 23 corresponds to an example of a control unit.

The area control unit 23 sets the display area on the display 41 and the operation area in which the touch sensor 42 accepts operations. The area control unit 23 can set the display area to the entire displayable area of the display 41, and to part of the displayable area thereof. The area control unit 23 can set the operation area to the entire detectable area of the touch sensor 42, and to part of the detectable area thereof. The position and extent of the display area and operation area set by the area control unit 23 are specified by, for example, the setting data 32.

The reception unit 21 detects operations onto the operation area set by the area control unit 23, and does not accept touch operations at positions out of the operation area.

The display control unit 22 causes characters and images to appear on the display area set by the area control unit 23 on the display 41, and does not cause them to appear at positions out of the display area thereon.

The vehicle 1 includes a steering wheel storage device 54. The steering wheel storage device 54 is a device that moves the steering wheel 55 with which the driver of the vehicle 1 performs steering operations. The steering wheel storage device 54 has a support mechanism that movably supports the steering wheel 55, and a drive source such as a motor that actuates the support mechanism. When the vehicle 1 is driven automatically by the driving assistance device 100, the driver does not need to operate the steering wheel 55. In such a case, the steering wheel 55 is stored by the steering wheel storage device 54, thereby allowing the driver to use a larger space in the passenger compartment of the vehicle 1. This improves convenience. The steering wheel storage device 54 is connected to the display device 10, and the display device 10 can actuate the steering wheel storage device 54 to move the steering wheel 55. In addition, the steering wheel storage device 54 is connected to the driving assistance device 100, and the driving assistance device 100 can actuate the steering wheel storage device 54 to move the steering wheel 55.

### 2. Arrangement of Devices in the Passenger Compartment

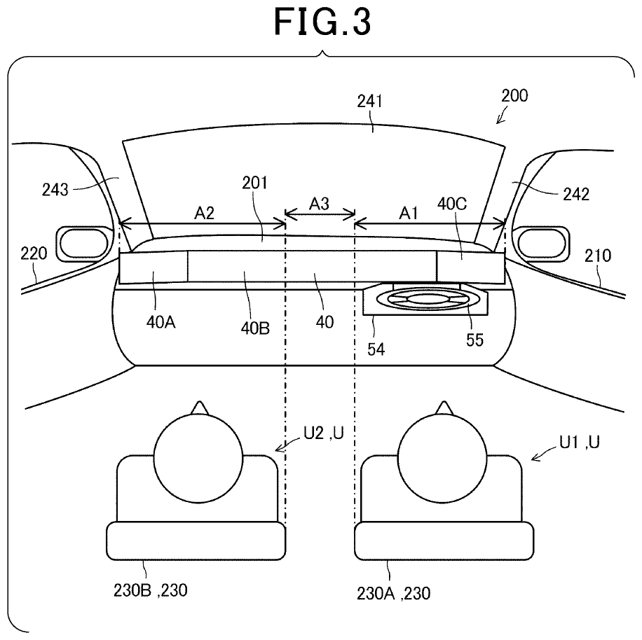

FIGS. 2 and 3 are perspective views of the main parts of a configuration example of the inside of the passenger compartment 200 of the vehicle 1, showing the front portion of the passenger compartment 200. These figures show an example of a configuration in which the driver's seat is provided on the right side of the passenger compartment 200, but by reversing the left and right, the configuration can also be applied to a vehicle 1 in which the driver's seat is provided on the left side of the passenger compartment 200.

The passenger compartment 200 is provided with a plurality of seats 230 in which occupants U of the vehicle 1 sit. In the configuration of FIG. 2, two seats 230 are disposed in the front portion of the vehicle 1, between the door 210 on the right side of the vehicle 1 and the door 220 on the left side of the vehicle 1. Of the two seats 230, a seat 230A is a driver's seat for a driver U1 who drives the vehicle 1 to sit, and a seat 230B is a passenger seat for a passenger U2 to sit. In other words, the driver's seat 230A in which the driver U1 rides and the passenger seat 230B (occupant seat) in which the passenger U2 rides are disposed side by side on the right and left in the front portion of the vehicle 1. A steering wheel 55 is located in front of the seat 230A. Note that, hereinafter, when the driver U1 is not distinguished from the passenger U2, they will be referred to as occupants U.

The display unit 40 is installed on the dashboard 201 in the front portion of the passenger compartment 200. When the traveling direction of the vehicle 1 is defined as the front direction, the display unit 40 has an elongated displayable area and detectable area that extend in the left-right direction. In the configuration of FIG. 2, the display unit 40 is a so-called pillar-to-pillar display that is installed over almost the entire area between the pillar 242 on the right side of the windshield 241 and the pillar 243 on the left side of the windshield 241. To make the pillar-to-pillar configuration, the display unit 40 is formed by connecting a plurality of panels. Specifically, the display unit 40 is formed by connecting a panel 40B that is arranged horizontally in the center of the front portion of the passenger compartment 200, a panel 40C located to the right of panel 40B, and a panel 40A located to the left of panel 40B. The panels 40A, 40B, and 40C each include a display panel that constitutes the display 41 and a touch sensor 42. The area control unit 23 can set the display area and the operation area over the boundaries between the panels 40A, 40B, and 40C.

The display unit 40 extends from the front of the driver's seat 230A to the front of the passenger seat 230B. The area of the display unit 40 that overlaps the front of the driver's seat 230A is defined as the driver's seat side area A1, and the area that overlaps the front of the passenger seat 230B is defined as the passenger seat side area A2. The area between the driver's seat side area A1 and the passenger seat side area A2 is the intermediate area A3. In other words, the driver's seat side area A1 is located in front of the driver U1, the passenger seat side area A2 is located in front of the passenger U2, and the intermediate area A3 is located between the driver U1 and the passenger U2.

The steering wheel 55 is supported by the steering wheel storage device 54. The steering wheel 55 moves to a position that can be operated by the driver U1, and to a position away from the driver U1 by the actuation of the steering wheel storage device 54. Here, of the positions of the steering wheel 55, the position where the driver U1 can operate the steering wheel 55 is called an operating position, and a position away from the operating position is called a non-operating position. In other words, the non-operating position is, for example, a position where the steering wheel 55 is away from the driver U1.

FIG. 2 shows a state where the steering wheel 55 is in the operating position. FIG. 3 shows a state where the steering wheel 55 has been moved to the non-operating position. In the non-operating position, the steering wheel 55 is stored below the dashboard 201 in a state in which the steering wheel 55 is tilted downward, as shown in FIG. 3, for example.

When the steering wheel 55 is moved to the non-operating position, a large space is created around the driver U1 in the passenger compartment 200, improving the livability of the passenger compartment 200. In addition, when the steering wheel 55 is in the non-operating position, the steering wheel 55 does not overlap the display unit 40 when viewed from the driver U1, so the driver U1 can clearly see the display unit 40. Therefore, while the vehicle 1 is traveling by automatic driving, moving the steering wheel 55 to a non-operating position can improve the comfort of the occupant U.

### 3. Display Area and Operation Area of the Display Unit

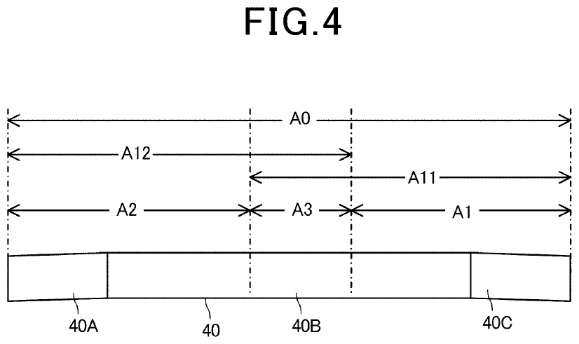

FIG. 4 is a diagram showing a setting example of the display area and operation area of the display unit 40, and shows an example of the display area and operation area set by the area control unit 23.

The driver's seat side area A1, passenger seat side area A2, and intermediate area A3 in FIG. 4 are areas described with reference to FIG. 2. The entire area A0 is the area of the entire display unit 40. In detail, the entire area A0 is the displayable area of the display 41 for the display area, and the entire detectable area of the touch sensor 42 for the operation area.

The first area A11 is the area of the entire area A0 excluding the passenger seat side area A2. In other words, the first area A11 is an area of the display unit 40 excluding the extent overlapping the front of the passenger seat 230B. The second area A12 is an area of the entire area A0 excluding the driver's seat side area A1. In other words, the second area A12 is an area of the display unit 40 excluding the extent overlapping the front of the driver's seat 230A, and in other word, the second area A12 is the area of the display unit 40 excluding the extent in front of the driver's seat.

The area control unit 23 sets the display area and the operation area depending on the driving state of the vehicle 1, etc. For example, when the vehicle 1 is driven manually, the driver U1 drives the vehicle by operating the steering wheel 55, etc., so it is not appropriate for the driver U1 to perform touch operations on the display unit 40. Furthermore, it is not appropriate for entertainment images to be displayed in the driver's seat side area A1. For this reason, for example, when the vehicle 1 is being driven manually, the area control unit 23 sets the display area and operation area to the second area A12 to restrict the display and operation in the driver's seat side area A1. In contrast, when the vehicle 1 is being driven automatically, it is preferable that the display and operation be performed using the entire display unit 40 including the driver's seat side area A1. For this reason, for example, when the vehicle 1 is being driven automatically, the area control unit 23 sets the display area and operation area to the entire area A0.

Furthermore, when the steering wheel 55 is in the operating position, the steering wheel 55 is located in front of the display unit 40 as seen by the occupants U, preventing operation of the display unit 40.

Therefore, the area control unit 23 appropriately sets and adjusts the display area and operation area in the display unit 40 based on the driving state of the vehicle 1 and the position of the steering wheel 55. The following describes specific examples of setting the display area and operation area.

### 4. Actuation of the Display Device

### 4-1. First Actuation Example

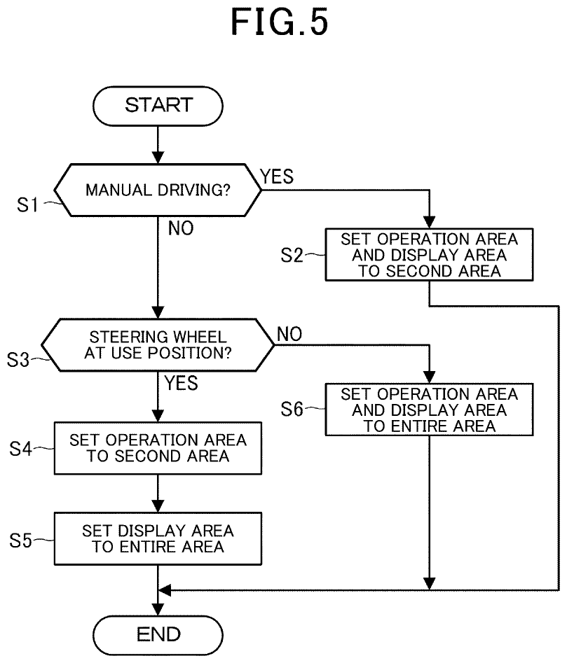

FIG. 5 is a flowchart showing an actuation example of the display device 10, and shows a first actuation example.

The first actuation example is an actuation in which the display device 10 detects the driving state of the vehicle 1 and the position of the steering wheel 55, and sets the display area and the operation area depending on the detection result.

Steps S1 to S6 in FIG. 5 are executed by the area control unit 23. The actuation in FIG. 5 is also executed repeatedly at a predetermined cycle while the display device 10 is running.

The display device 10 determines whether or not the driving state of the vehicle 1 is manual driving (step S1). If the vehicle 1 is being driven manually (step S1: YES), the display device 10 sets the operation area and display area of the display unit 40 to the second area A12 (step S2), and ends this process.

If the vehicle 1 is not in manual driving state, i.e., the vehicle 1 is in automatic driving state (step S1: NO), the display device 10 determines whether or not the steering wheel 55 is in the use position (step S3).

If the steering wheel 55 is in the use position (step S3: YES), the display device 10 sets the operation area to the second area A12 (step S4) and sets the display area to the entire area A0 (step S5).

When the vehicle 1 is automatically driven, it is preferable to make display using the entire display unit 40 in a large size to make the display easy to see. In contrast, if the steering wheel 55 is in the operating position, it is difficult for the occupants U to operate the driver's seat side area A1. Therefore, the operation area is set to the area excluding the driver's seat side area A1, thereby making it possible to prevent erroneous operation and to improve operability. In addition, when the vehicle 1 is manually driven, it is possible to restrict the operation in the driver's seat side area A1 to prevent inappropriate operation by the driver U1 during driving. In addition, since the passenger seat side area A2 and the intermediate area A3 can accept operation, advantageously preventing the operation by the passenger U2 from being hindered.

### 4-2. Second Actuation Example

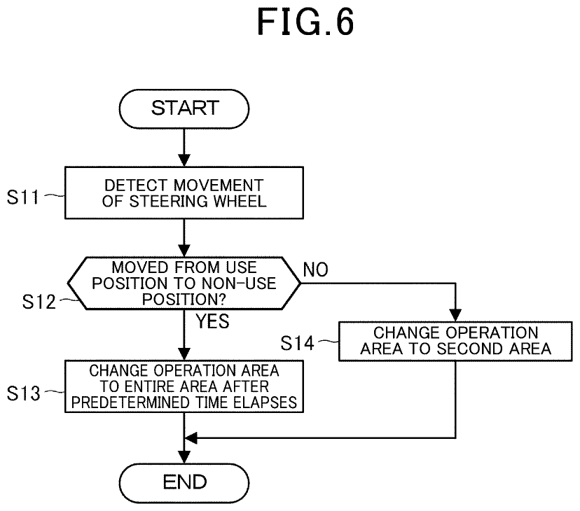

FIG. 6 is a flowchart showing an actuation example of the display device 10, and shows a second actuation example.

The second actuation example is an actuation in which the display device 10 detects a change in the position of the steering wheel 55 and sets the display area and the operation area in response to this change.

Steps S11 to S14 in FIG. 6 are executed by the area control unit 23. The actuation in FIG. 6 is executed by a trigger made in such a way that the display device 10 detects a change in the position of the steering wheel 55, i.e., the actuation of the steering wheel storage device 54 while the display device 10 is running.

When the display device 10 detects a movement of the steering wheel 55 (step S11), it determines whether or not the movement is from the use position to the non-use position (step S12). If the movement is a movement from the use position to the non-use position (step S12: YES), the display device 10 changes the operation area of the display unit 40 to the entire area A0 after a predetermined time elapses from when the steering wheel 55 completes the moving (step S13).

If the movement of the steering wheel 55 is not a movement from the use position to the non-use position (step S12: NO), the display device 10 sets the operation area to the second area A12 (step S14).

When the steering wheel 55 has been moved to the non-use position, it is preferable to make display using the entire display unit 40 in a large size to make the display easy to see. In contrast, if the steering wheel 55 is in the operating position, it is difficult for the occupant Us to operate the driver's seat side area A1. Therefore, the driver's seat side area A1 is excluded from the operation area, thereby making it possible to prevent erroneous operation and to improve operability.

### 4-3. Third Actuation Example

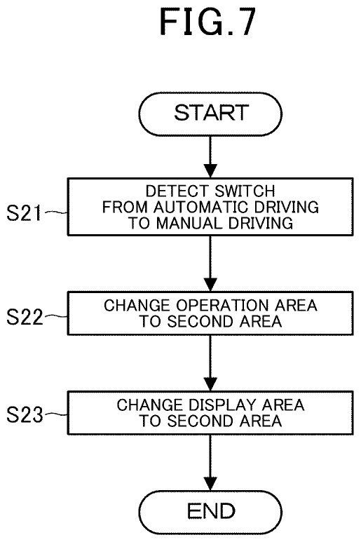

FIG. 7 is a flowchart showing an actuation example of the display device 10, and shows a third actuation example.

The third actuation example is an actuation in which the display device 10 detects a change in the driving state of the vehicle 1 and sets the display area and the operation area in response to this change.

Steps S21 to S23 in FIG. 7 are executed by the area control unit 23. The actuation in FIG. 7 is also executed by a trigger made in such a way that the display device 10 detects a change in the driving state of the vehicle 1 while the display device 10 is running.

If the display device 10 detects that the driving state of the vehicle 1 has been switched from automatic driving to manual driving (step S21), it changes the operation area of the display unit 40 to the second area A12 (step S22). After executing the change in step S22, the display device 10 changes the display area of the display unit 40 to the second area A12 (step S23).

In the third actuation example, as the driving assistance device 100 switches from automatic driving to manual driving, the display area of the display unit 40 is switched to the area excluding the driver's seat side area A1. This allows the driver U1 to recognize the switch from automatic driving to manual driving in a stepwise manner. When the display area of the display unit 40 is changed, the change of the operation area is completed, so that erroneous operation by the driver U1 can be reliably prevented.

### 4-4. Fourth Actuation Example

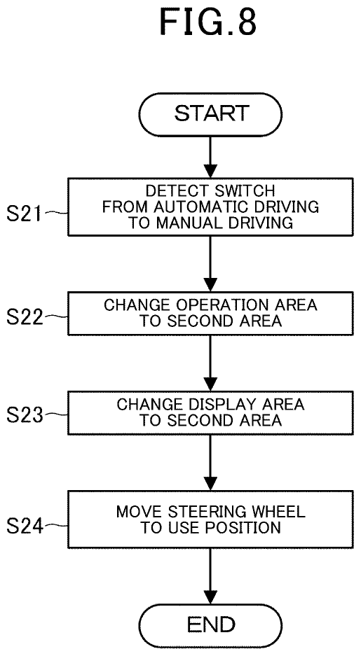

FIG. 8 is a flowchart showing an actuation example of the display device 10, and shows a fourth actuation example.

The fourth actuation example is an actuation in which the display device 10 detects a change in the driving state of the vehicle 1 and sets the display area and operation area in response to this change.

Steps S21 to S23 in FIG. 8 are the same actuation as those in FIG. 7. Furthermore, step S24 is executed by the area control unit 23. The actuation of FIG. 8 is executed by a trigger made in such a way that the display device 10 detects a change in the driving state of the vehicle 1 while the display device 10 is running.

If the display device 10 detects that the driving state of the vehicle 1 has been switched from automatic driving to manual driving (step S21), it changes the operation area of the display unit 40 to the second area A12 (step S22). After executing the change in step S22, the display device 10 changes the display area of the display unit 40 to the second area A12 (step S23).

Furthermore, the display device 10 actuates the steering wheel storage device 54 to move the steering wheel 55 from the non-use position to the use position (step S24).

In the fourth actuation example, as the driving assistance device 100 switches from automatic driving to manual driving, the display area of the display unit 40 switches to an area excluding the driver's seat side area A1, and the steering wheel 55 moves to the use position. This allows the driver U1 to recognize the switch from automatic driving to manual driving in a stepwise manner. Furthermore, in the fourth actuation example, the display device 10 controls the steering wheel storage device 54. The steering wheel 55 is moved after the operation area and the display area complete the change. Therefore, when the driver U1 is in a state where he/she can operate the steering wheel 55, the driver's seat side area A1 has been excluded from the operation area and the display area. Therefore, the display can be made without interfering with the operation of the steering wheel 55, preventing erroneous operation by the driver U1.

The first and second actuation examples can be executed in combination. The third and fourth actuation examples can be executed alternatively, and either one of the third and fourth actuation examples can be executed in combination with the first and second actuation examples.

### 5. Other Embodiments

The above embodiment is merely an embodiment of the present invention, and can be modified and applied as desired without departing from the gist of the present invention.

The configuration of the steering wheel storage device 54 and the steering wheel 55 shown in the above embodiment is an example. For example, the steering wheel storage device 54 may be configured to fold and store the steering wheel 55, or may be configured to completely store the steering wheel 55 in the dashboard 201. The steering wheel storage device 54 may be configured to change the angle of the steering wheel 55 to move the steering wheel 55 to the use position and the non-use position. The steering wheel storage device 54 may be configured to move the steering wheel 55 linearly in a direction toward the driver's seat 230A and a direction away from the driver's seat 230A.

FIG. 1 is a schematic diagram showing the configuration of the display device 10 divided according to the main processing contents in order to facilitate understanding of the present invention, and the configuration of the display device 10 may be divided in other ways. The processing of each component may be executed by one hardware unit or a plurality of hardware units. The processing of each component shown in FIGS. 5 to 8 may be executed by one program or a plurality of programs.

### 6. Configurations Supported by the Above Embodiments

The above embodiments support the following configurations.

(Configuration 1) A display device mounted on a vehicle, including: a display unit, wherein the vehicle has a driver's seat for a driver who drives the vehicle to sit and an occupant seat for a passenger of the vehicle to sit, the driver's seat and the occupant seat being arranged side by side, and the display unit is provided extending from the driver's seat to the occupant seat; an operation unit that receives an operation onto an operation area provided on the display unit; a display control unit that causes content to appear on a display area of the display unit; and a control unit that adjusts at least one of the operation area and the display area on the display unit depending on a driving state of the vehicle and a use state of a steering operation unit of the vehicle.

The display device of configuration 1 appropriately arrange the display area and operation area of the display unit, which are provided extending from the driver's seat to the occupant seat of the vehicle, making it possible to improve operability.

(Configuration 2) The display device according to configuration 1, wherein the vehicle can travel by manual driving in which the driver drives the vehicle with the steering operation unit, and by automatic driving, and the control unit sets the operation area and the display area to an area excluding an extent in front of the driver's seat when the vehicle travels by manual driving.

The display device of configuration 2 arranges the display area and operation area to exclude positions where there is concern that they may affect driving, when the vehicle is driven manually by the driver. This makes it possible to reduce the effect of the display and operation on driving, and prevent erroneous operation of the display unit during driving, improving operability.

(Configuration 3) The display device according to configuration 1 or 2, wherein the vehicle can travel by manual driving in which the driver drives the vehicle with the steering operation unit, and by automatic driving, the steering operation unit is movable to a use position in which the driver can operate the steering operation unit and to a non-use position that is out of the use position, and when the vehicle travels by automatic driving and the steering operation unit is in the use position, the control unit adjusts the operation area to an area excluding an extent in front of the driver's seat and adjusts the display area to an area of the entire display unit.

The display device of configuration 3 secures a large display area and arrange the operation area so as to exclude the position that overlaps the steering operation unit, when the vehicle travels by automatic driving. This makes it possible to improve the visibility of the display and prevent erroneous operation, improving operability.

(Configuration 4) The display device according to any of configurations 1 to 3, wherein the vehicle can travel by manual driving in which the driver drives the vehicle with the steering operation unit, and by automatic driving, the steering operation unit is movable to a use position in which the driver can operate the steering operation unit and to a non-use position that is out of the use position, and when the vehicle travels by automatic driving and the steering operation unit is located at the non-use position, the control unit adjusts the operation area and the display area to an area of the entire display unit.

The display device of configuration 4 can secure a wide display area and operation area, when the vehicle is in automatic driving in which no driving operation by the driver is required and when the steering operation unit does not interfere with display and operation. This makes it possible to increase the visibility of the display and enables operation in a wide operation area, thereby improving operability.

(Configuration 5) The display device according to any of configurations 1 to 4, wherein the steering operation unit is movable to a use position in which the driver can operate the steering operation unit and to a non-use position that is out of the use position, and when a position of the steering operation unit is changed from the use position to the non-use position, the control unit adjusts the operation area to an area of the entire display unit after a predetermined time elapses from detection of the change.

The display device of configuration 5 secures a wide operation area when the steering operation unit is moved to a non-use position where the steering operation unit does not interfere with display and operation, thereby making it possible to improve operability. Furthermore, the operation area is changed after the movement of the steering operation unit is reliably completed, thereby making it possible to prevent erroneous operation.

(Configuration 6) The display device according to any of configurations 1 to 5, wherein the vehicle can travel by manual driving in which the driver drives the vehicle with the steering operation unit, and by automatic driving, and when the vehicle switches from a state in which the vehicle travels by automatic driving to a state in which the vehicle travels by manual driving, the control unit adjusts the operation area from an area of the entire display unit to an area excluding an extent in front of the driver's seat, and then adjusts the display area from an area of the entire display unit to an area excluding an extent in front of the driver's seat.

The display device of configuration 6 changes the operation area and display area in a stepwise manner when the vehicle switches from automatic driving to manual driving, thereby making it possible to cause the driver to recognize the change to manual driving. In addition, the display area and the operation area are arranged so as to exclude the position where there is concern about the effect on driving, to make it possible to reduce the effect of the display and operation on driving and to prevent erroneous operation of the display unit during driving, thereby improving operability.

(Configuration 7) The display device according to any of configurations 1 to 5, wherein the vehicle can travel by manual driving in which the driver drives the vehicle with the steering operation unit, and by automatic driving, the steering operation unit is movable to a use position in which the driver can operate the steering operation unit and to a non-use position that is out of the use position, and when the vehicle switches from a state in which the vehicle travels by automatic driving to a state in which the vehicle travels by manual driving, the control unit adjusts the operation area and the display area from an area of the entire display unit to an area excluding an extent in front of the driver's seat, and then changes a position of the steering operation unit from the non-use position to the use position.

The display device of configuration 7 changes the operation area and the display area and then changes the steering operation unit to the use position when the vehicle switches from automatic driving to manual driving. This allows the driver to recognize the change to manual driving and then enables manual driving. In addition, the display area and the operation area are arranged so as to exclude positions where there is concern about the effect on driving. This makes it possible to reduce the effect of the display and operation on driving and to prevent erroneous operation of the display unit during driving, thereby improving operability.

(Configuration 8) A method of controlling a display device, the display device being provided in a vehicle having a driver's seat for a driver who drives the vehicle to sit and an occupant seat for a passenger of the vehicle to sit, the driver's seat and the occupant seat being arranged side by side, the display device including: a display unit extending from the driver's seat to the occupant seat; an operation unit that receives an operation onto an operation area provided on the display unit; and a display control unit that causes content to appear on a display area of the display unit, the method including adjusting at least one of the operation area and the display area on the display unit depending on a driving state of the vehicle and a use state of a steering operation unit of the vehicle.

The method of controlling the display device of configuration 8 appropriately arranges the display area and the operation area of the display unit extending from the driver's seat to the occupant seat of the vehicle, thereby making it possible to improve operability.

### Reference Signs List

1 . . . vehicle, 20 . . . CPU, 21 . . . reception unit (operation unit), 22 . . . display control unit, 23 . . . area control unit (control unit), 30 . . . memory, 31 . . . control program, 32 . . . setting data, 40A, 40B, 40C . . . panel, 41 . . . display, 42 . . . touch sensor, 51 . . . steering device, 52 . . . braking device, 53 . . . drive device, 54 . . . steering wheel storage device, 55 . . . steering wheel (steering operation unit), 100 . . . driving assistance device, 110 . . . control device, 111 . . . control program, 120 . . . sensor unit, 121 . . . camera, 122 . . . radar unit, 123. . . . GPS sensor, 200 . . . passenger compartment, 201 . . . dashboard, 210, 220 . . . door, 230A . . . driver's seat, 230B . . . passenger seat (occupant seat), 241 . . . windshield, 242, 243 . . . pillar, U . . . occupant, U1 . . . driver, U2 . . . passenger.

1. A display device mounted on a vehicle, comprising:
a display unit, wherein
the vehicle has a driver's seat for a driver who drives the vehicle to sit and an occupant seat for a passenger of the vehicle to sit, the driver's seat and the occupant seat being arranged side by side, and
the display unit is provided extending from the driver's seat to the occupant seat;
an operation unit that receives an operation onto an operation area provided on the display unit;
a display control unit that causes content to appear on a display area of the display unit; and
a control unit that adjusts at least one of the operation area and the display area on the display unit depending on a driving state of the vehicle and a use state of a steering operation unit of the vehicle.

2. The display device according to claim 1, wherein
the vehicle can travel by manual driving in which the driver drives the vehicle with the steering operation unit, and by automatic driving, and
the control unit sets the operation area and the display area to an area excluding an extent in front of the driver's seat when the vehicle travels by manual driving.

3. The display device according to claim 1, wherein
the vehicle can travel by manual driving in which the driver drives the vehicle with the steering operation unit, and by automatic driving,
the steering operation unit is movable to a use position in which the driver can operate the steering operation unit and to a non-use position that is out of the use position, and
when the vehicle travels by automatic driving and the steering operation unit is in the use position, the control unit adjusts the operation area to an area excluding an extent in front of the driver's seat and adjusts the display area to an area of the entire display unit.

4. The display device according to claim 1, wherein
the vehicle can travel by manual driving in which the driver drives the vehicle with the steering operation unit, and by automatic driving,
the steering operation unit is movable to a use position in which the driver can operate the steering operation unit and to a non-use position that is out of the use position, and
when the vehicle travels by automatic driving and the steering operation unit is located at the non-use position, the control unit adjusts the operation area and the display area to an area of the entire display unit.

5. The display device according to claim 1, wherein
the steering operation unit is movable to a use position in which the driver can operate the steering operation unit and to a non-use position that is out of the use position, and
when a position of the steering operation unit is changed from the use position to the non-use position, the control unit adjusts the operation area to an area of the entire display unit after a predetermined time elapses from detection of the change.

6. The display device according to claim 1, wherein
the vehicle can travel by manual driving in which the driver drives the vehicle with the steering operation unit, and by automatic driving, and
when the vehicle switches from a state in which the vehicle travels by automatic driving to a state in which the vehicle travels by manual driving, the control unit adjusts the operation area from an area of the entire display unit to an area excluding an extent in front of the driver's seat, and then adjusts the display area from an area of the entire display unit to an area excluding an extent in front of the driver's seat.

7. The display device according to claim 1, wherein
the vehicle can travel by manual driving in which the driver drives the vehicle with the steering operation unit, and by automatic driving,
the steering operation unit is movable to a use position in which the driver can operate the steering operation unit and to a non-use position that is out of the use position, and
when the vehicle switches from a state in which the vehicle travels by automatic driving to a state in which the vehicle travels by manual driving, the control unit adjusts the operation area and the display area from an area of the entire display unit to an area excluding an extent in front of the driver's seat, and then changes a position of the steering operation unit from the non-use position to the use position.

8. A method of controlling a display device,
the display device being provided in a vehicle having a driver's seat for a driver who drives the vehicle to sit and an occupant seat for a passenger of the vehicle to sit, the driver's seat and the occupant seat being arranged side by side,
the display device including: a display unit extending from the driver's seat to the occupant seat; an operation unit that receives an operation onto an operation area provided on the display unit; and a display control unit that causes content to appear on a display area of the display unit,
the method comprising adjusting at least one of the operation area and the display area on the display unit depending on a driving state of the vehicle and a use state of a steering operation unit of the vehicle.
